(19) United States
(12) Patent Application Publication
(10) Pub. No.: US 2012/0259917 A1
(43) Pub. Date: Oct. 11, 2012

(54) METHOD AND APPARATUS FOR EXCHANGING INFORMATION BETWEEN PARTIES

(76) Inventors: Dan TYROLER, Great Neck, NY (US); Liat Amosy, Great Neck, NY (US)

(21) Appl. No.: 13/080,967

(22) Filed: Apr. 6, 2011

(51) Int. Cl. G06F 15/16

(52) U.S. Cl. 709/204

(57) ABSTRACT

A system providing automated delivery of contact information between users of two respective devices. The request for predetermined contact information is recognized at the device of one of the parties and in response, the requested contact information is sent automatically to the second user. The device of the second user stores the contact information and uses to send specific information to the first user. The memory holding the contact information and/or the address books can be local storage devices or cloud based.

### RELATED APPLICATIONS

None

### BACKGROUND OF THE INVENTION

1. Field of Invention

The present invention pertains to a method and apparatus for exchanging predetermined information, such as contact information between two or more parties involved in a communication.

2. Description of the Prior Art

Today two or more parties can engage in various forms of communication that may be either contemporaneous (e.g., full or half duplex) or not. In either case, frequently while parties are exchanging messages in one media, they would like to exchange messages or send messages and data from one to the other using_same communication channel they already established or a different communication channel. (In this application, the term “media” is used to cover various types of communication channels such as land-to-land analog telephone conversations, cell phone communications, e-mails, texting, etc.) However, while two or more parties may know the contact information required to perform communications on one media, different contact information may be required for another media, contact information that may not be readily available and may be difficult to transmit.

Some contact information is presently available for some media. For example, when one party calls another, the second may see the phone number of the first through caller ID. However, this feature is not always available. Some early cell phones included IR transceivers that allowed two people to exchange some contact information if their cell phones were physically close enough for such communication. This IR exchange was possible only while the cell phones were not in use. Of course, if the two cell phone users were distant from each other, the IR transceivers were useless. Recent phones, including smart phone no longer have this feature.

There are many other instances in which two or more parties need to exchange contact information. In the present application, the term contact information is used to cover any information or other data that is generally specific to a particular individual, particularly if he is a party to the communication, including but not limited to name, e-mail address, business address, home address, web address, picture, cell phone, home phone, fax number, etc. For example while party A is talking to party B over a cell phone, party B may ask party A for A's e-mail address so that B can send data to A as part of an e-mail message. A then has to look up his e-mail address, and then dictate it to B. B then has to copy A's email address by hand, enter it in his PC or smart phone and then use it for the e-mail message with new data. Of course if the line is noisy, if A has an accent, or B is hard of hearing or does not speak the same language as very well, or A's e-mail address is complicated, or due to many other factors, there is a very good chance that B records A's e-mail address incorrectly and therefore is unable to send the additional data.

### SUMMARY OF THE INVENTION

There is presently a need for two or more parties engaged in communication with each other to send to another or exchange information, such as contact information quickly, automatically and accurately. Data exchange could be provided as part of a service from a third party entity with the users being members in the third party entity, such as matchmaker in which case pictures and personal data to be exchanged or contact information such as user id of social networking users are part of. this purpose, each party has a device adapted to provide communication with the other party or parties and, in addition, in response to commands, to provide contact information to the other parties. At the receiving end, the contact information is stored in an appropriate address book or other data record depending on the exchanged data, the specific setup or configuration used by a particular party, and so on. In more complex configurations, external servers may be used to store and transmit the user contact information.

### BRIEF DESCRIPTION OF THE FIGURES

FIG. 1 shows diagrammatically two parties engaged in communication in accordance with this invention;

FIG. 2 shows a first method used in the invention for exchanging information;

FIG. 3 shows a second method used in the invention for exchanging information; and

FIG. 4 shows a generalized, cloud based implementation of the invention.

### DETAILED DESCRIPTION OF THE INVENTION

In general, because of the many communication channels and methods that are available these days, the methodology set forth above is just one demonstration of one of many possible solution and methods, describing one specific solution when parties are communicating via cell phone. Other applicable solution methods could be applied accordingly and appropriately on the other communication channels.

Also, the solution could be different from one communication channel, from one device to another communication channels or another device, as required by their individual parameters, characteristics and protocols.

One simple common solution is to pre-store the relevant information (ahead of time, or while going to the device/service set-up or other configuration mode). While in this special mode, the user defines, enters and stores this relevant information (i.e., his contact information) into a local memory or other appropriate and applicable storage means such as server, or other remote data storage site, including cloud-based data storage sites, etc.) This contact information or CI (e.g., email address, home or office address, home, office, fax, cell phone number and/or any other relevant information) could be stored locally in the device (cell phone, land line phone etc) or into the back office device (server) of the service provider. This pre-stored information is then shared/provided to the other party when user enter a pre-defined command (could be a key sequence, voice command, etc.) which causes the contact information to be sent to the other party where it is stored, forwarded to the other party's email address book, displayed on the phone screen or other designated places. In case data is stored into the phone or service provider memory, the other party could access this storing area using his access procedure including password.

In another embodiment the CI is sent to the other party's memory (on his device or on his service provider storage area) using a predefined email address for the receiving address. The email address of the receiving party is also pre-stored in his device or in the party's service provider memory and is available to be forwarded to the first party. The transfer of data could be done directly over the open communication path the parties are communicating on or indirectly: from one server provider to the other server provider where each provider identifies the destination and information by knowing the phone number (as an example) of each party.

The CI n could be transferred by the parties, while talking on the phone, after the party issued a special key sequence entry or any type pf command (voice or other) and the other party who received the information forward this information to a pre-defined location (email, device display, stored memory, server etc).

Many different means of initiating a transfer command, depending on the device which is used by the first party (cell phone, land line etc), depending on the technology used in the device (the phone or other device) and depending on the technology used by the services supporting the devices (the providers). These parameters determine how the CI is stored initially, transferred, and then stored for the receiving party.

For example, user A entered his/her email address in the cell phone (device). When user is having a conversation with another party, and asked to provide his email address, instead of saying and spelling user's email address, overriding at the same time the noise, accent and language barrier, the user is pressing a special predefined key sequence (ex: “*”+“e”) and optionally also a password. Upon recognizing this key sequence and password, the device (cell phone or other, preferably hand-held, devices) is transmitting the data that consists of the user's email (in this case, but could be any other relevant data). The data transfer could be done by any of the conventional data transfer methods such as DTMF (dual tone multiple frequency) or FSK (frequency shift keying) or any other data transfer protocol that will be suitable depending on the communication channel and provider that are used.

The data in this example could have been stored on the provider server or on the phone itself, all depending on the data structure, the device capabilities and technical arrangements of the provider of the user.

After data was sent out, it is received by the other party, who has the capability to perform the appropriate operation (storing the data, decoding the data and forwarding the information to the receiver's email box or displaying the info on the receiver's phone display or other available destinations.) The entire operation is completely automated except the initial command initiated by the user to start the data transfer—in above mentioned example—the user email address. If applicable, no initial command is required and the entire data exchange is automated as long as user pre set it up for complete automated transfer and as long as the user device or user service provider was configured and capable to operate in an automated data exchange mode.

The device could be any other type of communication device supported by the appropriate technical back office (server, provider etc). The transfer of the data could be selected to be fly automated (always transmitted to the other party) or sent after user issue a command or even sent after the receiving party (the other person on the phone) issue the request. It is up to the users and providers to configure the mode of operation of this data transfer. It is very possible that in order for this function to work that it will require both users' providers to be compatible and support this data transfer.

The transfer or sending of CI can be implemented by creating a universal protocol (or use existing protocols) in order for the different providers to be able transforming the data and forwarding it accordingly.

The data transfer could be done over the already established communication path (audio path) or indirectly via the providers themselves via standard communication channels (internet, server to server etc. . . . ).

This concept should be also available when multiple parties are present on the conference call. This time multiple parties are sharing their information among themselves.

The procedure to start transferring the info (email or other info) could be protected also by password so only the authorized person could initiate the data/information transfer/sharing.

The data sharing/transfer could also be initiated from the other party in case the source of the data/information already authorized it (by entering a command and password on his side).

The data could be transferred over the same communication channel that the parties are communicating (example: audio over the phone or over the VoIP channel) or also in between the servers of the providers that handle the parties account. Example: once the data transfer was authorized (after issuing a command and password) data exchange could be done indirectly (behind, at the back offices) between the servers (in case different providers handle the communicating parties) or on the same company's servers in case provider is common. Like that the information does not need to be passed via the open communicating channel (audio, VoIP or other similar channel) but digitally between the providers of the parties that are communicating at the present time. The providers themselves retrieve the information (email, etc.) from the parties and forwarding it to the other party/parties or after identifying the information by looking at the different phone numbers of the parties (or their account_and their associated emails (pre-stored)) in the case of the example of forwarding the email.

As previously mentioned, the CI could be pre-stored either on the communicating device (such as a cell or a land line phone for example) or on the server belonging to the communication provider or on the web in general. The CI could include other general information applicable for many uses. For example, private/personal information about a person, including description (age, gender etc) including person picture could be pre-stored (match making service). A special service could be established that create a social networking via the communicating devices and or via the web. Upon a special command (such as a key sequence) this data could be transferred to the other interested party. Example: member is communicating with another member via a cell phone. Upon request (that is authorized by the parties) a picture and other personal information could be exchanged between the parties and displayed on the cell phone screen while they are performing regular communication (talking). The information could be retrieved from the memory in the cell phone, or from the memory on the provider server or from a web site that was created specifically for this purpose. This example demonstrated other type of data that is transferred from one device to another, from server to server, from server to device, etc. Moreover, the information can also be sent to and/or from a web- or cloud-based application. The data is transferred while parties are communicating between themselves (e.g., possibly talking on the phone). This type of data transfer could be very easily done by writing a special application program that resides in the Iphone. The application program will perform the appropriate functions to retrieve the data and transfer it to the final destination. The information could be referred to the appropriate pre-stored memory by referring to the member's phone number.

This is just another type of data transfer for another usage (compared to the email exchange). As before member password or other security means could be used to control and authorize the data transfer/exchange.

When parties are talking/communicating between each other, and one or more party is entering (for example via the phone keypad) a key sequence command, the provider of the other party receives this command and reacts accordingly (by transmitting all or a portion of the CI to one or more parties). The provider performs different actions depending on the received command and depending on the pre-defined set of functions the party has with his provider or services that the provider offer. The same could also be performed not necessary by the other provider who “captured” the command but by the provider of the original user, which will perform all the necessary actions (talk to the other provider if required or perform other necessary actions) and end up performing the task. In one embodiment of the invention, if the CI is provided by a processor associated with a provider or server, the respective processor monitors the conversation between two parties for tones generated by keys on the respect device, indicating that one of the parties has requested the exchange of CI. When the command is recognized by the respective processor, the respective CI is sent to the other party.

The provider may also provide this “back office” services that result in information or command or any data transfer directly back to the parties (in real time for example back to the phone and be displayed) or to another destination that was pre-defined by users or defined by the providers (example to the email of the other user)

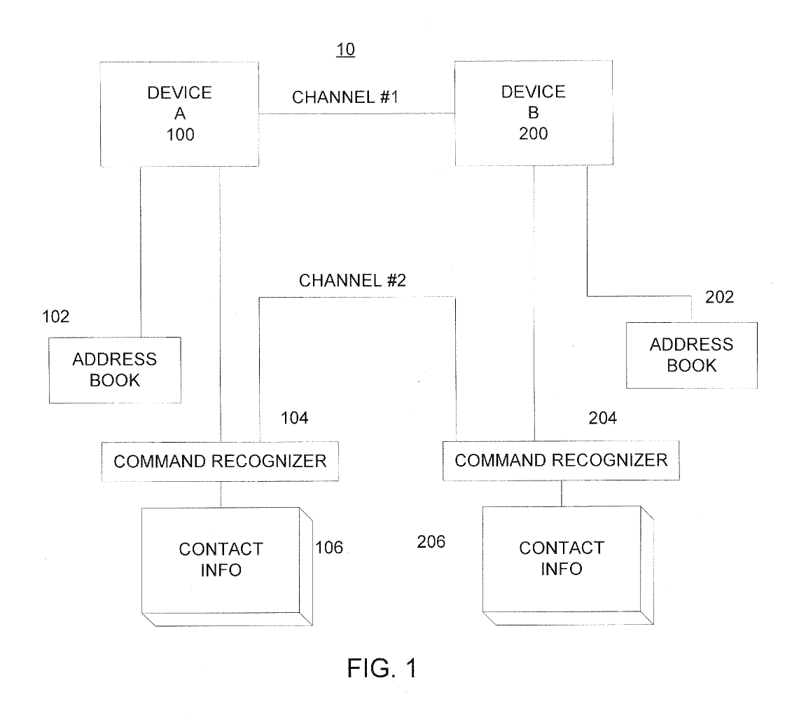

A somewhat simplified embodiment illustrating the invention is shown in FIGS. 1-3. In these Figures, a system 10 incorporating the subject invention is shown in FIG. 1. In this system, two users A, B use two respective devices 100, 200 to communicate with each other over a standard communication channel #1. Each of the devices is associated with an address book 102, 202, a command recognizer 104, 204 and a memory 106, 206 containing contact information (CI) for the respective device or user. It should be understood that the elements just described are shown as discrete elements for the sake of clarity, but are best implemented integrally within the respective devices 100, 200 by corresponding hardware, firmware or software.

Various commands and other signals or data can be entered by the respective user on keys 108, 208.

The contact information in memory 106, 206 can be obtained from the address book but because it may contain more or less data then what is in the address book, it is preferably implemented separately.

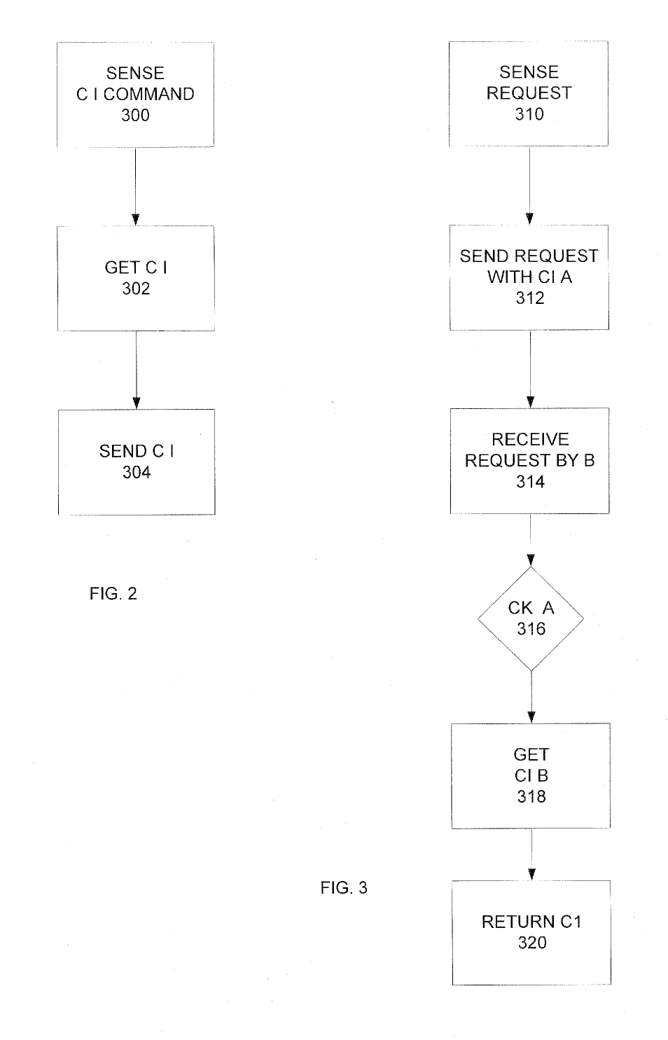

FIG. 2 shows one method for using the invention. At a given instance in time, users A and B are communicating with each other over channel #1. During the communication, user B requests some specific contact information from user A. This contact information may be A's home, office, or cell phone number, fax number, home or office address, email address, webpage, blog page, etc. As discussed preferably this C I is found in memory 106.

The user A on receiving B's request, activates either a dedicated key or a sequence of conventional keys on keyboard 108. Alternatively, if his device 100 is properly equipped, he waves his hand a certain way, or emits certain key words or phrases. Alternatively, a combination of these actions are taken by user A to issue a command to send the CI information. The command is sensed by recognizer 104 (step 300), the CI is retrieved from memory 106 (step 302) and in step 304 the CI is sent by the device 100 to device 200. The device 200 is then stores the CI of A in address book 202. The CI is sent either on the same channel #1 or over a secondary channel #2, The information may be sent in any well known format such ASCII codes, and using encoding modes such as DTMF, FSK, etc. Of course, if a second channel #2 is used, a special protocol must be established to inform the devices what this channel is and how the signals thereon should be addressed. The process is reversed when user A requests the CI information of user B.

In another embodiment, other communication paths may be used as channels of communication. These may be provided by other providers, where all the decoding it self could be residing also in that provider's equipment. Such channel could be for example over IP where data is exchanged from one user's server to the other user's server. Also exchange of data could be done via an intermediate website that does all the decoding and data exchange between the parties.

Of course, the memory 106 may contain more information than what user B wants or is entitled to get. Therefore in one embodiment, user A may issue one of several commands, each command specifying a different subset of CI from memory 106. For example, one command may request the whole record. Another command may request only the home phone number, a third command may request only A's email address, and so on.

FIG. 3 shows another embodiment. In this embodiment, instead user A requesting user B orally for his CI, user A issues a command on his device 100 for generating a request to device 200 by activating keyboard 108 or by using other oral, manual, visual, or mechanical means. In step 310 the command is sensed, for example by recognizer 104. The recognizer 104 then generates a request that incorporates a return address for A, e.g., his email address.

In step 312 the request is sent to the device 200. In step 314 the request is received

In step 316 the request is checked to see what portion of B's CI has been requested and what portion of this available information can be released to A. For this purpose, device 200 may include a separate table listing all the users of the system and what each user is allowed to receive.

In step 318 the requested CI for B is obtained form memory 206 (assuming A is entitled to it and in step 320 the information CI for B is returned to A using the information available from the initial request, such as his email address.

Devices 100, 200 have been described as cell phones for the sake of clarity but can be other devices, such as landline telephones, VoIP telephones, PCs, laptops, tablets, etc.

It should be emphasized that data exchange could be any data and not just contact information. The type and amount of data transmitted will depend on the needs and requirements of different businesses and other entities. For instances matchmaking services can have their members transfer pictures, personnal information automatically between each otherby having this information pre stored and transferred between members Alternatively, contact information of members can be exchanged between different services such as medical services to transfer patient data etc. Data transfer could be done as I indicated in between back offices (servers) and not necessary data that is stored locally on the user device (cell phone etc. . . . ).

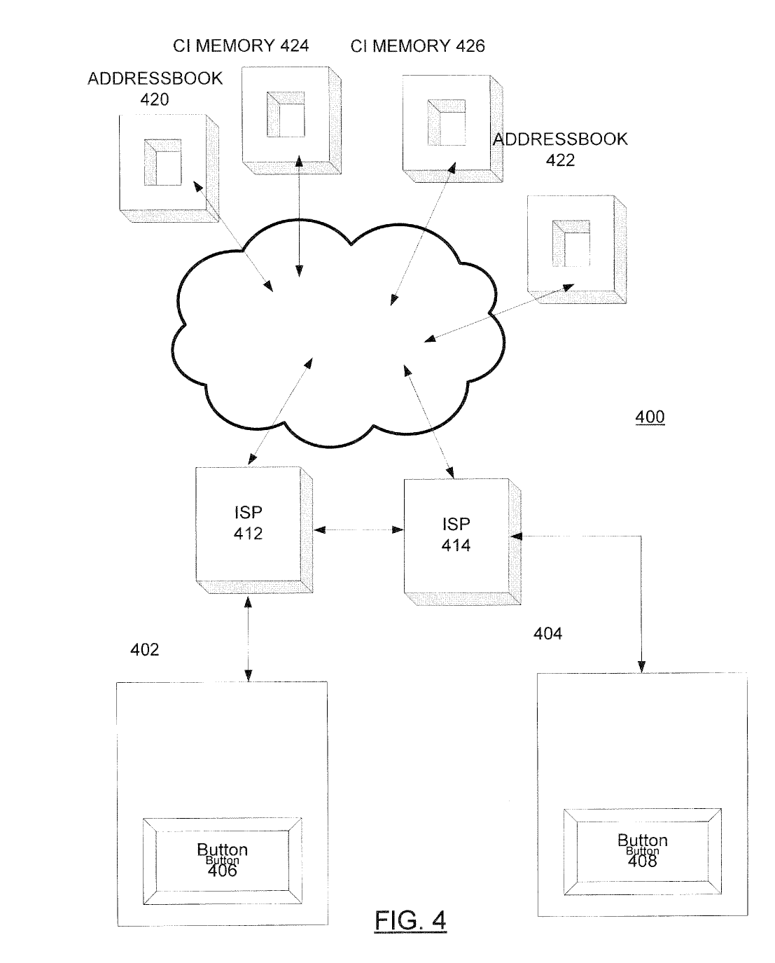

FIG. 4 shows a generalized, cloud based embodiment of the invention. In this embodiment, in system 400 two users are communicating through two devices 402, 404 through respective ISPs 412, 414, servers or other types of devices capable of performing the functionality described. Each device is associated with its own addressbook 420, 422 and CI memory 424, 426. As the two users are communicating with each other, an event may be triggered that requires exchange of some type of CI between the two users. For example, one may activate its actual or virtual button, 406, 408, or a hot key. Other events that may trigger a CI exchange may include uttering certain sounds or words by either user, pressing a combination of standard keys on the devices 402, 404, etc. The two devices may communicate directly, through their ISP or through the cloud.

The devices 402, 404 are associated with recognizers (not shown) incorporated into either the devices themselves, In the ISP or some other servers. Once an event requiring a CI is recognized, one of the devices or servers access the appropriate CI m,emory through the cloud, withdraws the necessary information and transmits it to the address book of the other user. Moreover, different events may trigger the retrieval of different portions of the CI, e.g., only, the cell phone numbers, only the local address, only the e-mail address, etc.

Numerous modifications may be made to the invention without departing from its scope as defined in the appended claims.

We claim:

1. A communication system providing communications between two users comprising:
a first device used by a first user;
a second device used by a second user; wherein at least said first device includes a first recognizer recognizing a predetermined event in response to which a section of contact information is retrieved from a memory and transferred to said second device, said contact information allowing said second user to send a further communication to said first user over a predetermined channel.

2. The system of claim 1 wherein said second device is associated with an address book, said contact information being stored in said address book.

3. The system of claim 1 wherein said event corresponds to said first user selectively activating a switch dedicated to this purpose.

4. The system of claim 1 wherein said first device has a set of general purpose keys and said event includes activating a subset of said general purpose keys.

5. The system of claim 1 wherein said event is a voiced utterance from said first user.

6. The system of claim 1 wherein at least one of said memory and address book are data storage devices disposed locally.

7. The system of claim 1 wherein at least one of said memory and said address book are cloud-based devices.

8. The system of claim 1 wherein each device is serviced by a server and wherein, in response to said event, one of said servers retrieves said contact information and transmits it to the other server.

9. The system of claim 1 wherein each device is serviced by a server and wherein, in response to said event, one of said servers retrieves said contact information and transmits it to the other device.

10. The system of claim 1 wherein at least one of said servers is one of an ISP, server and a web based and a cloud based application.
